(19) United States
(12) Patent Application Publication
(10) Pub. No.: US 2013/0253795 A1
(43) Pub. Date: Sep. 26, 2013

(54) BRAKING SYSTEM AND A METHOD FOR BRAKING A VEHICLE IN THE CASE OF ABRUPT CHANGES IN THE FRICTION COEFFICIENT

(71) Applicants: Rainer Brueggemann, Ludwigsburg (DE); Andreas Reize, Adelsheim (DE); Phillip Frueh, Clayton (AU)

(72) Inventors: Rainer Brueggemann, Ludwigsburg (DE); Andreas Reize, Adelsheim (DE); Phillip Frueh, Clayton (AU)

(21) Appl. No.: 13/992,964

(22) PCT Filed: Oct. 17, 2011
(86) PCT No.: PCT/EP11/68069

§ 371 Date: Jun. 10, 2013

(30) Foreign Application Priority Data
Dec. 10, 2010 (DE) 102010062816.6

(51) Int. Cl. B60T 8/1763

(52) U.S. Cl. CPC B60T 8/1763
USPC 701/80

(57) ABSTRACT

A brake device is described for braking the wheels of a vehicle. The brake device includes at least one brake master cylinder, a brake booster, a wheel brake, a return pump, using which a hydraulic fluid may be pumped back from the wheel brake in the direction of brake master cylinder. A sensor system for detecting an abrupt negative change in the friction coefficient of the roadway is provided. An arrangement is provided according to which the boost of the brake booster is set to a smaller value if a braking maneuver has been detected on a roadway having an abrupt negative change in the friction coefficient than in the case of a braking maneuver on a roadway without an abrupt negative change in the friction coefficient.

### FIELD OF THE INVENTION

The present invention relates to a braking system for a vehicle having an improved braking characteristic in a driving situation in which the vehicle brakes on a roadway having an abrupt negative change in the friction coefficient, as well as a method for braking a vehicle in a corresponding driving situation.

### BACKGROUND INFORMATION

Various brake control systems, such as ABS, ASR, or ESP, are known from the related art, using which the wheels may be prevented from blocking during the braking action. These systems generally monitor the wheel slip with the aid of the wheel speed sensors. If the brake control system detects an excessively high wheel slip on a wheel, the brake pressure is temporarily reduced in the associated wheel brake. For this purpose, an outlet valve is usually opened. The brake fluid present in the wheel brake then flows through the outlet valve into a storage chamber and is conveyed from there back in the direction of the brake master cylinder with the aid of a return pump.

In certain braking situations, e.g., emergency braking actions in which a relatively high brake pressure acts on the wheel brakes, it may occur that the return pump is not capable of conveying the brake fluid back fast enough, resulting in the storage chamber filling up. In this case, the brake pressure acting on the wheel brake is reduced more slowly than is desirable, so that the associated wheel remains blocked longer than necessary. In this state, the vehicle is known to be unsteerable and becomes unstable. In principle, it would be possible to enlarge the storage chamber or the return pump, but this is uneconomical for cost reasons and thus undesirable.

### SUMMARY

It is thus an object of the previous invention to provide a brake device for braking vehicles and a corresponding method using which the standstill periods of the wheels may be reduced in the case of an ABS braking action, without having to enlarge the dimensions of the storage chamber or the return pump.

According to an exemplary embodiment of the present invention, it is proposed to reduce the boost of the brake booster in driving situations in which the vehicle executes a braking maneuver using ABS control on a roadway having an abrupt negative change in the friction coefficient. Since in the case of an ABS control the return pump works against the brake pressure generated in the brake master cylinder, a reduction of the brake boost results in a lower brake master cylinder pressure and thus in a smaller load on the return pump. The return pump thus has a comparably higher conveying power and is accordingly able to convey more hydraulic fluid from the wheel brakes back in the direction of the brake master cylinder. In this way, the standstill periods of the wheels may, in turn, be reduced in the case of an ABS control.

A brake device according to an exemplary embodiment of the present invention accordingly includes an arrangement for automatically setting a lower boost of the brake booster when the vehicle executes a braking maneuver using ABS control on a roadway having an abrupt negative change in the friction coefficient.

The boost of the brake booster may be influenced in the case of an underpressure brake booster with the aid of the vacuum pump, for example. The previously mentioned arrangement for setting the boost of the brake booster may thus include a vacuum pump and a control unit, for example, with the aid of which the vacuum pump may be activated as desired.

In the case of a braking maneuver on a roadway having a high friction coefficient, the brake master cylinder and thus also the brake booster make a relatively large lift. In this way, the underpressure level in the vacuum chamber of the brake booster is reduced and the absolute pressure is increased, whereby the boost of the brake booster is, in turn, reduced. In conventional braking systems, the vacuum pump would start in this case to compensate for this effect. According to an exemplary embodiment of the present invention, it is now proposed to comparably reduce the power of the vacuum pump. For this purpose, the start of the vacuum pump may be suppressed, for example, or the vacuum pump may start with a delay. In this way, the boost of the brake booster is lower compared to a braking maneuver on a roadway having an approximately constant friction coefficient. In braking situations on a roadway having an abrupt negative change in the friction coefficient, the brake pressure generated by the brake master cylinder is thus comparably lower than in braking situations on a roadway without an abrupt negative change in the friction coefficient.

To detect an abrupt negative change in the friction coefficient, i.e., a transition from a roadway area having a higher friction coefficient (e.g., asphalt) to a roadway area having a smaller friction coefficient (e.g., ice), a suitable sensor system is preferably provided. The sensor system preferably includes at least one wheel speed sensor. Another, e.g., an optical sensor system, may also be used.

An abrupt negative change in the friction coefficient of the roadway may, for example, be detected by monitoring the wheel speeds. As soon as the vehicle drives from a roadway section having a high friction coefficient to a roadway section having a significantly smaller friction coefficient and brakes at the same time, the front wheels experience a slip, while the rear wheels experience considerably less slip. An abrupt negative change in the friction coefficient may thus be detected when the wheel slip of the front wheels exceeds a predefined first threshold value and the wheel slip of the rear wheels is less than a predefined second threshold value.

According to one embodiment of the present invention, the underpressure level in the vacuum chamber of the brake booster is monitored by sensors and the vacuum pump is operated as a function of the underpressure level. In the case of a very low absolute pressure, the vacuum pump is not or is only able to start with a delay during an ABS control, as mentioned previously. In the case of a slightly higher absolute pressure, the vacuum pump may, for example, be operated with slightly less power than in the case of an ABS braking action on a roadway having an approximately constant friction coefficient.

### BRIEF DESCRIPTION OF THE DRAWINGS

FIG. 1 schematically shows a brake circuit of a hydraulic braking system.

FIG. 2 schematically shows a vehicle on a roadway having an abrupt negative change in the friction coefficient.

FIG. 3 shows a flow chart of a specific embodiment of a method according to the present invention.

### DETAILED DESCRIPTION

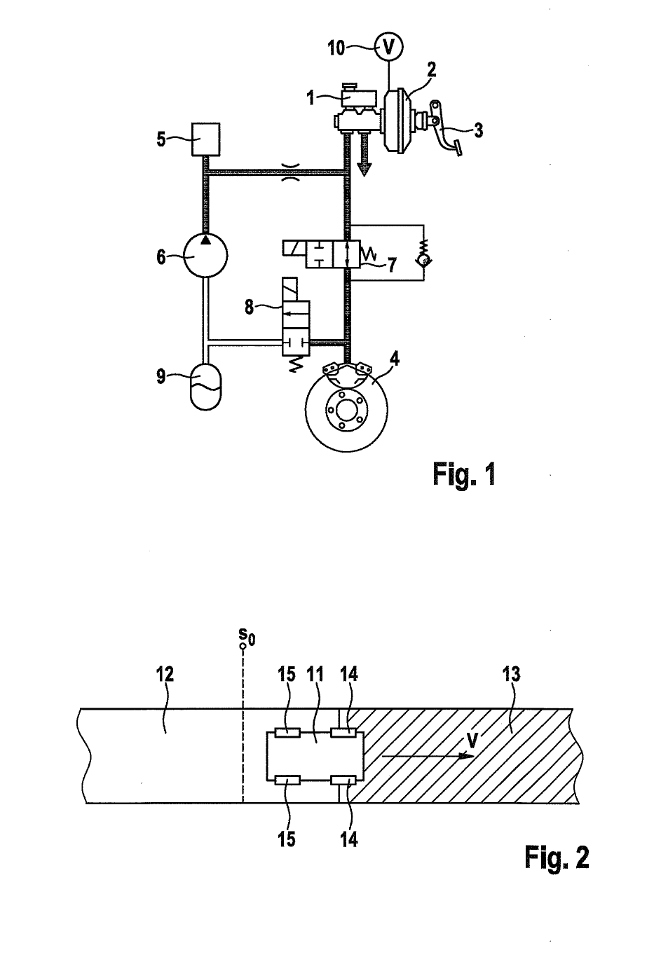

FIG. 1 shows a typical brake circuit of a hydraulic braking system having an ABS function. This brake circuit includes a brake master cylinder 1 having a container for the hydraulic fluid situated thereon. A brake booster 2 is coupled to a brake pedal 3 and boosts the brake force applied by the driver.

The brake pressure generated in brake master cylinder 1 is guided to a wheel brake 4 via an inlet valve 7. An outlet valve 8 situated at the output of wheel brake 4 is closed in this state.

FIG. 2 shows a vehicle 11 which drives at a speed v on a roadway having different friction coefficients. The roadway has an area 12 having a relatively high friction coefficient μ, such as asphalt, and an area 13 having a relatively small friction coefficient μ, such as snow or ice. Vehicle 11 is in a braking operation which has started in place s₀.

In the illustrated position, front wheels 14 of vehicle 11 are directly at the transition between area 12 having the high friction coefficient and area 13 having the small friction coefficient. The transition between the two areas 12, 13 is also referred to as an abrupt negative change in the friction coefficient

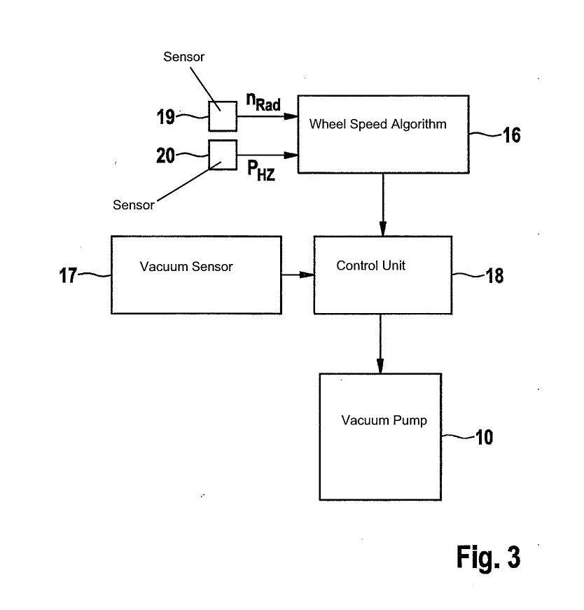

As soon as front wheels 14 of vehicle 11 reach area 13 having the small friction coefficient, they block and show an accordingly high wheel slip. The wheel slip is monitored with the aid of wheel speed sensors 19 (see FIG. 3) while driving. In the illustrated situation, rear wheels 15 are still in area 12 having a higher friction coefficient and thus show significantly less wheel slip.

As soon as an increased wheel slip has been determined on front wheels 14, the ABS controller becomes active. As a result, inlet valve 7 is closed and outlet valve 8 is opened. The hydraulic fluid present in wheel brake 4 thus flows from wheel brake 4 into a storage chamber 9 (see FIG. 1) and is conveyed from there back in the direction of brake master cylinder 1 with the aid of a so-called return pump 6. A buffer 5 is provided at the output of return pump 6 for the damping of the system.

During the starting phase of the braking operation, when vehicle 11 is still in roadway area 12, a relatively large amount of brake fluid of brake master cylinder 1 is shifted into wheel brake 4, brake booster 2 executing an accordingly large lift. In this way, the pressure in the vacuum chamber of brake booster 2 rises. During a braking maneuver on a roadway having a uniform friction coefficient, a vacuum pump 10 would start in this case to compensate for this effect. According to an embodiment of the present invention, it is now provided for the illustrated special case of a braking action on a roadway having an abrupt negative change in the friction coefficient to reduce the boost of brake booster 2 compared to a braking maneuver on a roadway having a constant friction coefficient, or to not compensate for the reducing boost of the brake booster.

According to one preferred specific embodiment of the present invention, vacuum pump 10 is therefore not activated or only activated with a delay during braking maneuvers on a roadway having an abrupt negative change in the friction coefficient. Optionally, it may also be operated with comparably less power. As a result, the hydraulic brake pressure generated in brake master cylinder 1 is reduced. The consequence is that return pump 6 which works against the brake master cylinder pressure is subjected to a smaller load and thus runs faster. In this way, the brake pressure on wheel brake 4 may be reduced faster so that the wheel starts rotating faster. The vehicle is thus steerable again more rapidly.

FIG. 3 shows once again the individual method steps of a method for operating a vehicle braking system during a braking maneuver on a roadway having an abrupt negative friction coefficient. Such a driving situation is detected by an algorithm 16 which analyzes wheel speeds n_{wheel} of individual wheels 14, 15 and brake pressure p_{HZ}. Mentioned variables n_{wheel} and p_{HZ} are measured with the aid of corresponding sensors 19 and 20. When brake pressure p_{HZ} acting on brake master cylinder 1 is greater than a predefined threshold value, e.g., 100 bar, and the wheel slip on wheels 14 of the front axle is also greater than a first threshold value, e.g., 20%, and the wheel slip on wheels 15 of the rear axle is less than a second threshold value, e.g., 5%, a braking maneuver on a roadway having an abrupt negative change in the friction coefficient is detected. In this case, a signal is transmitted to a control unit 18 of vacuum pump 10. Control unit 18 then activates vacuum pump 10 as a function of the underpressure level in brake booster 1 which is measured by an associated vacuum sensor 17. When the pressure in the vacuum chamber of the brake booster is relatively low—the boost of the brake booster is in this case relatively high—the start of vacuum pump 10 is suppressed, for example, and vacuum pump 10 is not activated. However, if the pressure is higher—the boost of the brake booster is rather low—the vacuum pump may also be operated with little power, for example.

1-8. (canceled)

9. A brake device for braking a wheel of a vehicle, comprising:
at least one brake master cylinder;
a brake booster;
a wheel brake;
a return pump, wherein a hydraulic fluid is pumped back from the wheel brake in a direction of the at least one brake master cylinder;
a sensor system for detecting an abrupt negative change in a friction coefficient of a roadway; and
an arrangement for setting a boost of the brake booster to a smaller value if a first braking maneuver has been detected on the roadway having the abrupt negative change in the friction coefficient than in a case of a second braking maneuver on the roadway without the abrupt negative change in the friction coefficient.

10. The brake device as recited in claim 9, wherein the arrangement includes a control unit and a vacuum pump.

11. The brake device as recited in claim 9, wherein the sensor system includes at least one wheel speed sensor and a sensor for detecting a braking operation.

12. A method for braking a wheel of a vehicle, comprising:
monitoring an occurrence of an abrupt negative change in a friction coefficient of a roadway; and
setting a boost of a brake booster to a smaller value if a first braking maneuver has been detected on the roadway having the abrupt negative change in the friction coefficient than in a case of a second braking maneuver on the roadway without the abrupt negative change in the friction coefficient.

13. The method as recited in claim 12, further comprising:
monitoring one of a brake pressure and a variable depending on the brake pressure; and
setting a lower boost of the brake booster when the brake pressure is greater than a predefined threshold value and the abrupt negative change in the friction coefficient has been detected.

14. The method as recited in claim 12, further comprising:
monitoring at least one wheel speed of a front wheel and one wheel speed of a rear wheel to detect an occurrence of the abrupt change in the friction coefficient.

15. The method as recited in claim 12, further comprising one of:
operating a vacuum pump with less power; and
temporarily deactivating the vacuum pump to set a lower boost of the brake booster, so that the brake booster one of does not start and starts with a delay in the case of an ABS control.

16. The method as recited in claim 12, further comprising:
monitoring an underpressure level in the brake booster by a sensor to determine a measured underpressure; and
operating a vacuum pump as a function of the measured underpressure.
